(19) United States
(12) Patent Application Publication
(10) Pub. No.: US 2025/0302114 A1
(43) Pub. Date: Oct. 2, 2025

(54) AEROSOL GENERATING DEVICE

(71) Applicant: KT&G Corporation, Daejeon (KR)

(72) Inventor: Sangkyu PARK, Seoul (KR)

(73) Assignee: KT&G Corporation, Daejeon (KR)

(21) Appl. No.: 18/864,144

(22) PCT Filed: May 11, 2023
(86) PCT No.: PCT/KR2023/006398

§ 371 Date: Nov. 8, 2024

(30) Foreign Application Priority Data
May 17, 2022 (KR) 10-2022-0060439
Aug. 23, 2022 (KR) 10-2022-0105764

(51) Int. Cl. A24F 40/51; A24F 40/20; A24F 40/465

(52) U.S. Cl. CPC A24F 40/51; A24F 40/465; A24F 40/20

(57) ABSTRACT

An aerosol generating device is provided. The aerosol generating device includes: a body shaped to define an insertion space; a heater located within the insertion space; a sensing coil positioned around the insertion space; a capacitance sensor coupled to the sensing coil and being configured to measure a capacitance in a vicinity of the sensing coil; an inductive sensor coupled to the sensing coil and being configured to measure an inductance in the vicinity of the sensing coil; and a switch configured to electrically connect the sensing coil to any one of the capacitance sensor or the inductive sensor.

### TECHNICAL FIELD

The present disclosure relates to an aerosol generating device.

### BACKGROUND ART

An aerosol generating device is a device that extracts certain components from a medium or a substance by forming an aerosol. The medium may contain a multi-component substance. The substance contained in the medium may be a multi-component flavoring substance. For example, the substance contained in the medium may include a nicotine component, an herbal component, and/or a coffee component. Recently, various research on aerosol generating devices has been conducted.

### DISCLOSURE OF INVENTION

### Technical Problem

It is an objective of the present disclosure to solve the above and other problems.

It is another objective of the present disclosure to provide an aerosol generating device capable of detecting various changes using one sensor.

It is yet another objective of the present disclosure to provide an aerosol generating device with improved sensing sensitivity or sensing accuracy.

### Solution to Problem

According to one aspect of the subject matter described in this application, an aerosol generating device includes: a body shaped to define an insertion space; a heater located within the insertion space; a sensing coil positioned around the insertion space; a capacitance sensor coupled to the sensing coil and being configured to measure a capacitance in a vicinity of the sensing coil; an inductive sensor coupled to the sensing coil and being configured to measure an inductance in the vicinity of the sensing coil; and a switch configured to electrically connect the sensing coil to any one of the capacitance sensor or the inductive sensor.

### Advantageous Effects of Invention

According to at least one of the embodiments of the present disclosure, an aerosol generating device capable of detecting various changes through one sensor may be provided.

According to at least one of the embodiments of the present disclosure, an aerosol generating device with improved sensing sensitivity or sensing accuracy may be provided.

Further scope of applicability of the present disclosure will become apparent from the following detailed description. However, it should be understood that the detailed description and specific embodiments such as preferred embodiments of the present disclosure are given by way of example only, since various changes and modifications within the idea and scope of the present disclosure may be clearly understood by those skilled in the art.

### BRIEF DESCRIPTION OF DRAWINGS

FIGS. 1 to 18 illustrate examples of an aerosol generating device according to embodiments of the present disclosure.

### MODE FOR THE INVENTION

Description will now be given in detail according to exemplary embodiments disclosed herein, with reference to the accompanying drawings. For the sake of brief description with reference to the drawings, the same or equivalent components are provided with the same or similar reference numerals, and description thereof will not be repeated.

In the following description, a suffix such as “module” and “unit” may be used to refer to elements or components. Use of such a suffix herein is merely intended to facilitate description of the specification, and the suffix itself is not intended to give any special meaning or function.

In the present disclosure, that which is well known to one of ordinary skill in the relevant art has generally been omitted for the sake of brevity. The accompanying drawings are used to help easily understand the technical idea of the present disclosure and it should be understood that the idea of the present disclosure is not limited by the accompanying drawings. The idea of the present disclosure should be construed to extend to any alterations, equivalents, and substitutes besides the accompanying drawings.

It will be understood that although the terms “first”, “second”, etc. may be used herein to describe various elements, these elements should not be limited by these terms. These terms are only used to distinguish one element from another.

It will be understood that when a component is referred to as being “connected to” or “coupled to” another component, it may be directly connected to or coupled to another component, or intervening components may be present. On the other hand, when a component is referred to as being “directly connected to” or “directly coupled to” another component, there are no intervening components present.

As used herein, a singular representation is intended to include a plural representation unless the context clearly indicates otherwise.

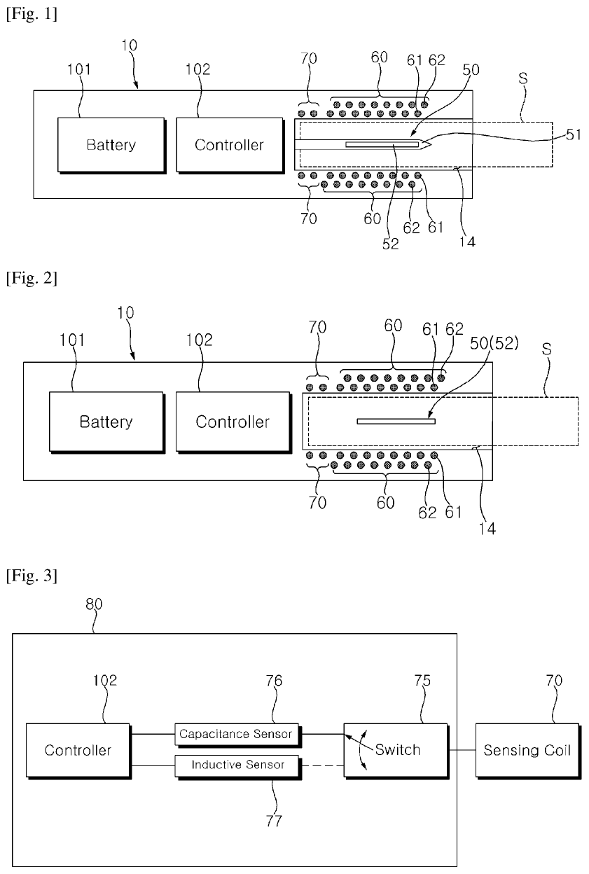

Referring to FIGS. 1 and 2, an aerosol generating device may include at least one of a battery 101 and a controller 102. At least one of the battery 101 and the controller 102 may be disposed inside a body 10 of the aerosol generating device. The body 10 may have a shape elongated in an up-and-down direction.

A stick S may be inserted into the body 10. A lower end of the stick S may be inserted into the body 10, and an upper end of the stick S may protrude out of the body 10. A user may inhale air while holding the upper end of the stick 200 exposed to the outside in his or her mouth. The body 10 may have an insertion space 14 open at the top to allow the stick S to be inserted therein. A heater 50 may heat the stick S. The heater 50 may be disposed in the insertion space 14.

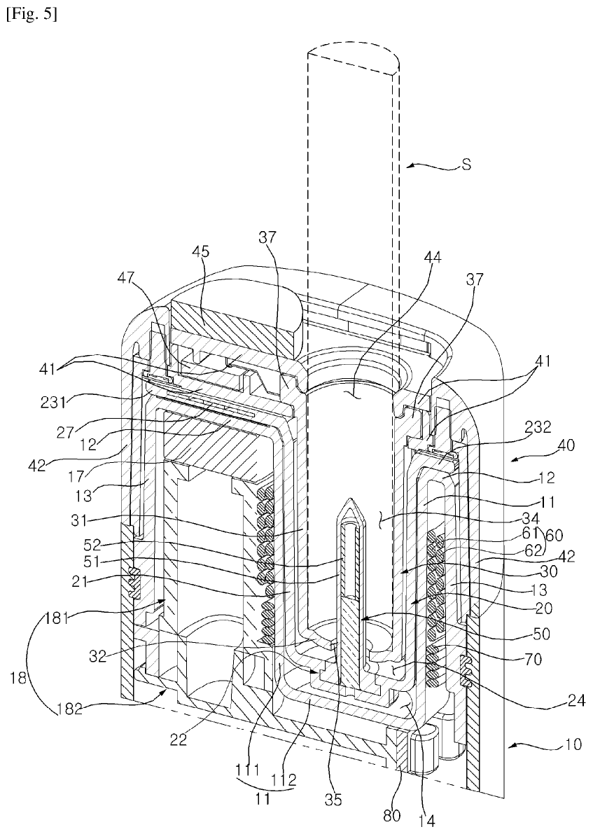

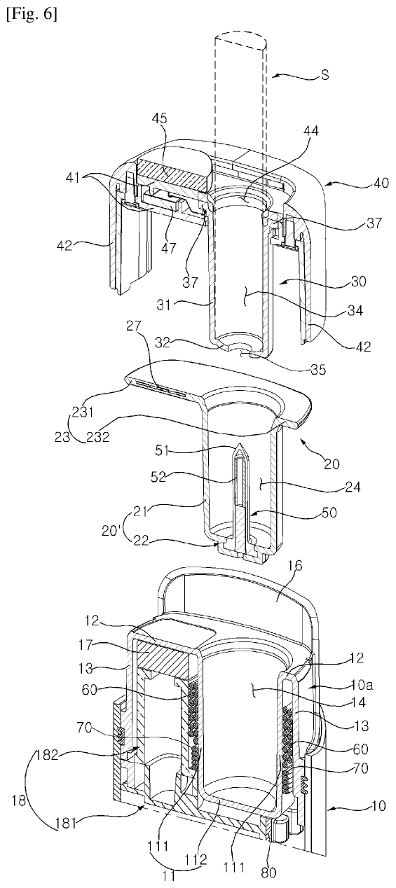

Referring to FIG. 1, the aerosol generating device may include the heater 50. The heater 50 may protrude upward from a bottom of the insertion space 14. The heater 50 may be detachably coupled to the body 10 (see FIGS. 5 and 6).

The heater 50 may include a heater rod 51. The heater rod 51 may define an exterior (or outer appearance) of the heater 50. The heater rod 51 may be elongated in the up-and-down direction. The heater rod 51 may have a cylindrical shape. The heater rod 51 may have a cavity open at the bottom. The heater rod 51 may have a pointed top end (or tip). The heater rod 51 may have high thermal expandability, excellent thermal insulation, and low thermal conductivity. The heater rod 51 may have high rigidity. For example, the heater rod 51 may be made of zirconia. However, the material of the heater rod 51 is not limited thereto.

The heater 50 may include a heating portion 52. The heating portion 52 may be inserted into the cavity of the heater rod 51. The heating portion 52 may be elongated in the up-and-down direction. The heating portion 52 may have a cylindrical shape. The heating portion 52 may be made of a resistive metal. Heat generated from the heating portion 52 may be transferred to an outside of the heater 50 through the heater rod 51. The heating portion 52 may be disposed at a height corresponding to a third insertion space 34.

Referring to FIG. 2, a heating portion 52 of a heater 50 may be fixed inside the stick S, and the heater 50 may be disposed in the insertion space 14 when the stick S is inserted into the insertion space 14. When the stick S is removed from the insertion space 14, the heater 50 may be separated from the insertion space 14.

The aerosol generating device may include an induction coil 60 surrounding the heater 50. The induction coil 60 may surround the insertion space 14. The induction coil 60 may cause the heater 50 to generate heat. The heater 50 may be a susceptor, and the heating portion 52 of the heater 50 may generate heat by a magnetic field generated by an AC current flowing through the induction coil 60. The magnetic field may pass through the heater 50, and may generate an eddy current in the heater 50. The current may cause the heating portion 50 to generate heat. Heat generated from the heating portion 52 may pass through the heater rod 51 and then be transferred to an outside of the heater 50. The induction coil 60 may be disposed at a height corresponding to the heating portion 52.

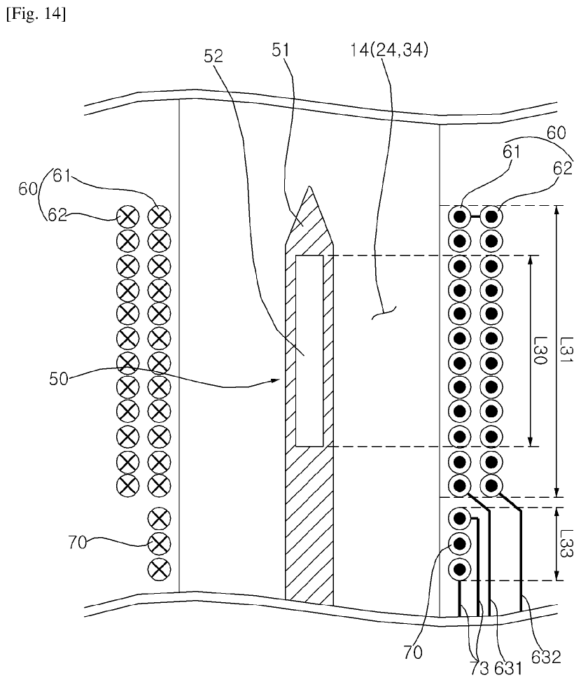

The induction coil 60 may include an inner coil 61 and an outer coil 62. The inner coil 61 and the outer coil 62 may be wound around the insertion space 14. The outer coil 62 may be disposed outside the inner coil 61. The inner coil 61 and the outer coil 62 may be integrally formed with each other. One end of the inner coil 61 and one end of the outer coil 62 may be connected to each other. The outer coil 62 may extend from the one end of the inner coil 61 so as to be wound around the inner coil 61. The outer coil 62 and the inner coil 61 may be wound in the same direction (see FIG. 14). A radius of the outer coil 62 may be greater than a radius of the inner coil 61.

Accordingly, without increasing a length in the up-and-down direction, namely, a vertical length of the coil, the strength of a magnetic field may be increased by increasing the number of turns of the coil. In addition, as an outer surface of the coil is formed flat, matching with an outer attachment structure may be improved. This will be described later.

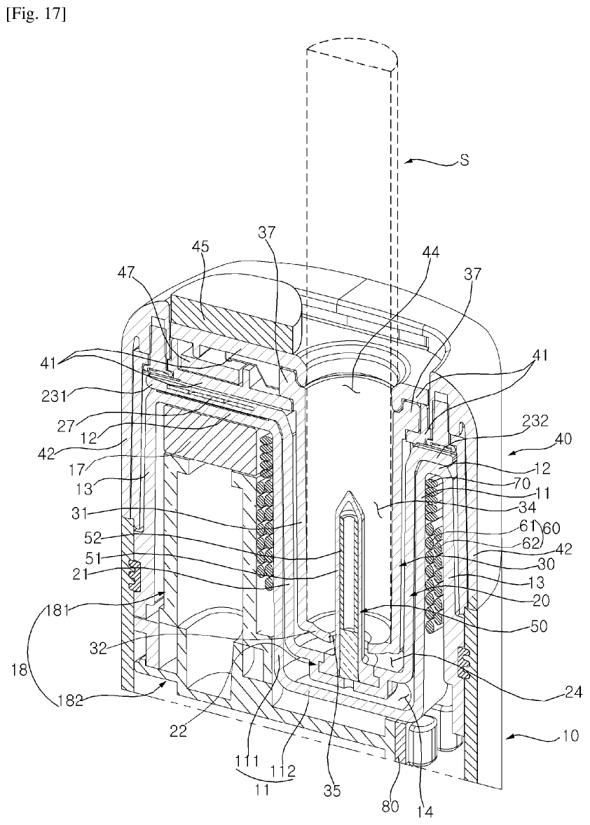

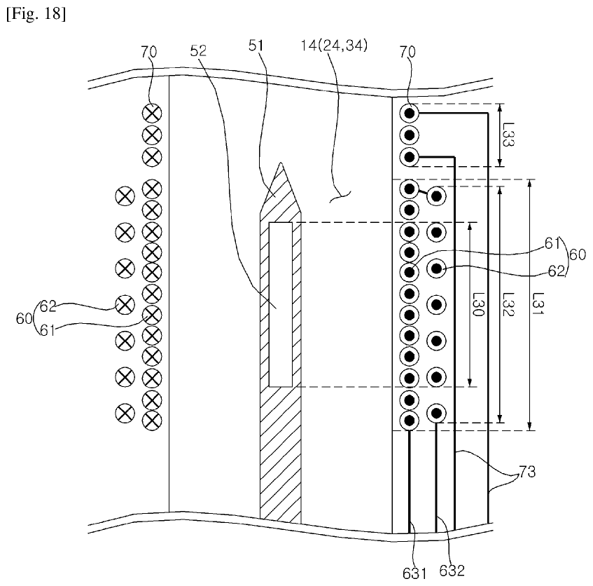

The aerosol generating device may include a sensing coil 70. The sensing coil 70 may surround a portion of the insertion space 14. The sensing coil 70 and the induction coil 60 may be arranged up and down. For example, the sensing coil 70 may be disposed below the induction coil 60. As another example, the sensing coil 70 may be disposed above the induction coil 60 (see FIGS. 17 and 18). In order to improve sensing sensitivity, the disposition of the sensing coil 70 may be adjusted in consideration of the position of the heater 50 or the stick S.

The battery 101 may supply power to operate components of the aerosol generating device. The battery 101 may supply power to at least one of the controller 102, the heater 50, the induction coil 60, and the sensing coil 70. The battery 101 may supply power required to operate a display, a motor, and the like installed at the aerosol generating device.

The controller 102 may control the overall operation of the aerosol generating device. The controller 102 may control the operation of at least one of the battery 101, the heater 50, the induction coil 60, and the sensing coil 70. The controller 102 may control the operation of the display, the motor, and the like installed at the aerosol generating device. The controller 102 may check the state of each of the components of the aerosol generating device to determine whether the aerosol generating device is in an operable state. The controller 102 may receive a value sensed by the sensing coil 70 to determine the state (or status) of the surroundings.

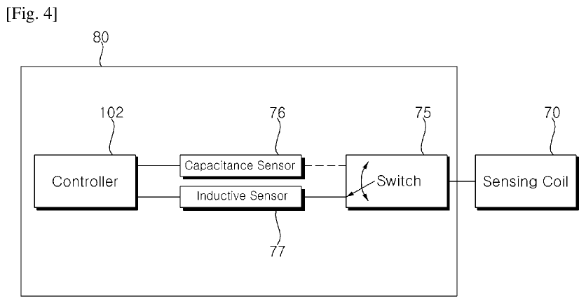

Referring to FIGS. 3 and 4, the controller 102 may be mounted on a substrate 80. Alternatively, the substrate 80 may be electrically connected to another substrate on which the controller 102 is mounted. A capacitance sensor 76 may be mounted on the substrate 80. The capacitance sensor 76 may be connected to the controller 102. An inductive sensor 77 may be mounted on the substrate 80. The inductive sensor 77 may be connected to the controller 102. A switch 75 may be mounted on the substrate 80. The switch 75 may be connected to any one of the capacitance sensor 76 and the inductive sensor 77. The switch 75 may switch a connection from one of the capacitance sensor 76 and the inductive sensor 77 to the other. The switch 75 may be referred to as a switching element 75. The substrate 80 may be electrically connected to the battery 101 (see FIGS. 1 and 2). The controller 102 may control the operation of the switch 75.

The sensing coil 70 may be electrically connected to the substrate 80. The sensing coil 70 may be connected to any one of the capacitance sensor 76 and the inductive sensor 77 through the switch 75. The switch 75 may release the connection between the sensing coil 70 and the capacitance sensor 76, and then connect the sensing coil 70 with the inductive sensor 77. The switch 75 may release the connection between the sensing coil 70 and the inductive sensor 77, and then connect the sensing coil 70 with the capacitance sensor 76. The sensing coil 70 may be connected to the capacitance sensor 76 to measure a capacitance value of the surroundings. The sensing coil 70 may be connected to the inductive sensor 77 in the vicinity thereof to measure an inductance value. A change in capacitance and a change in inductance may vary according to a change in state of an object in the vicinity of the sensing coil 70. The controller 102 may detect or determine various states based on the capacitance value. The controller 102 may detect or determine various states based on the inductance value. The controller 102 may control the operation of various components of the aerosol generating device based on the detected state.

For example, in the case of the stick S inserted into the insertion space 14, the degree of dampness (or moisture content) may vary depending on the extent of use. Here, a change in capacitance near the sensing coil 70 may occur, and the capacitance value in the vicinity of the sensing coil 70, which is measured by the capacitance sensor 76, may vary. Accordingly, the controller 102 may detect the extent of use of the stick S.

For example, the capacitance value in the vicinity of the sensing coil 70 measured by the capacitance sensor 76 may vary depending on whether or not the stick S is inserted into the insertion space 14. Accordingly, the controller 102 may detect whether the stick S is inserted into the insertion space 14.

For example, the inductance value in the vicinity of the sensing coil 70 measured by the inductive sensor 77 may vary depending on whether or not the stick S is inserted into the insertion space 14. Accordingly, the controller 102 may detect whether the stick S is inserted into the insertion space 14.

For example, the inner and outer materials of the stick S may vary depending on the type of stick S, and the inductance value in the vicinity of the sensing coil 70 measured by the inductive sensor 77 may vary depending on the type of stick S inserted into the insertion space 14. Accordingly, the controller 102 may detect which type of stick S is inserted into the insertion space 14.

A change in capacitance may be more sensitive to a change in moisture content, which is more suitable for recognizing the used amount of the stick S. A change in inductance may be more suitable for recognizing a particular stick S. In consideration of this, the controller 102 may control the switch 75 to connect the capacitance sensor 76 and the sensing coil 70 for recognizing the used amount of the stick S. The controller 102 may control the switch 75 to connect the inductive sensor 77 and the sensing coil 70 for recognizing the type of stick S.

The function of the sensing coil 70 is not limited to the description described above, and the sensing coil 70 may be used so long as the same can function as determining the state of the surroundings using elements that cause a change in capacitance or a change in inductance. To this end, a lookup table showing capacitance values in the vicinity of the sensing coil 70 measured by the capacitance sensor 76 and corresponding changed states of the surrounding environment may be stored in a memory. Also, a lookup table showing inductance values in the vicinity of the sensing coil 70 measured by the inductive sensor 77 and corresponding changed states of the surrounding environment may be stored in the memory.

Accordingly, a change in capacitance and a change in inductance may be sensed using one sensor. In addition, by separating a region where the induction coil 60 heats the heater 50 and a region where the sensing coil 70 senses, noise contributed by the induction coil 60 to the sensing may be reduced (see FIGS. 1 and 2). Further, the sensing coil 70 may be disposed closer to the insertion space 14 or the stick S, thereby improving sensing sensitivity or accuracy (see FIGS. 1 and 2).

Referring to FIGS. 5 and 6, the body 10 may have a first insertion space 14 therein. The first insertion space 14 may be open at the top. The first insertion space 14 may have a cylindrical shape elongated vertically. The first insertion space 14 may be defined by a body pipe 11 provided inside the body 10. The body pipe 11 may include a lateral wall 111 surrounding a circumference of the first insertion space 14 and a lower wall 112 covering a bottom of the first insertion space 14. The lower wall 112 may be formed at a bottom of the body pipe 11. The lateral wall 111 of the body pipe 11 may be referred to as an inner lateral wall 111 of the body 11.

A heater holder 20 may be detachably inserted into the first insertion space 14. The heater holder 20 may have a second insertion space 24 therein. The second insertion space 24 may be open at the top. The second insertion space 24 may have a cylindrical shape. The second insertion space 24 may be defined by a pipe 20′ of the heater holder 20. The pipe 20′ may include a lateral wall 21 surrounding a circumference of the second insertion space 24 and a lower wall 22 covering a bottom of the second insertion space 24. The lower wall 22 of the pipe 20′ may be referred to as a bottom 22 or a mount 22. The lower wall 22 of the pipe 20′ may define a bottom of the heater holder 20. The heater 50 may be coupled or fixed to the heater holder 20. The pipe 20′ may be referred to as a heater holder pipe 20′.

The extractor 30 may be detachably inserted into the second insertion space 24. The extractor 30 may have a third insertion space 34 therein. The third insertion space 34 may be open at one side. The third insertion space 34 may have a cylindrical shape. The third insertion space 34 may be defined by a lateral wall 31 and a lower wall 32 of the extractor 30. An outer circumferential surface of the extractor 30 may have a cylindrical shape.

A lower end of the stick S may be inserted into the third insertion space 34, and an upper end of the stick S may protrude out of the aerosol generating device. The heater 50 may heat the first insertion space 14, the second insertion space 24, and the third insertion space 34. The heater 50 may heat the stick S inserted into the third insertion space 34.

Accordingly, the heater 50 may be easily replaced. The replacement of the insertion space 14, 24, 34 and the heater 50 disposed in the insertion space 14, 24, 34 may be difficult due to their small sizes. However, a user may easily replace the heater 50 by removing the heater holder 20 from the aerosol generating device and then placing a new heater holder 20 into the aerosol generating device.

In addition, a foreign material (or impurity) generated from the stick S may be extracted through the extractor 30 without remaining in the vicinity of the heater 50 and in the heater holder 20. Accordingly, cleaning of the aerosol generating device, namely, around the heater 50 may be facilitated, and the convenience of management may be improved. Also, a replacement period of the heater 50 may be extended by reducing factors that decrease the performance of the heater 50 and by improving the durability of the heater 50. Further, factors that change the taste of the stick S may be reduced.

A lower end of the heater 50 may be fixed to the mount 22. The heater 50 may be elongated toward the opening of the second insertion space 24. The heater 50 may be formed in a cylindrical shape, and may have a pointed top end. As another example, the heater 50 may have a shape extending in a circumferential direction, and may be coupled to the lateral wall 21 of the heater holder 20. However, these are merely an example of the shape of the heater 50, and the shape of the heater 50 is not limited to those described above or shown in the drawings. Any other shapes may be used so long as the shape allows the heater 50 to heat the stick S inserted into the third insertion space 34 by being coupled to the heater holder 20.

The heater holder 20 may be insert-injected to the heater 50. The heater holder 20 may have high heat resistance and excellent rigidity. For example, the heater holder 20 may be made of polyetheretherketone (PEEK). However, the material of the heater holder 20 is not limited thereto.

The lower wall 32 of the extractor 30 may be open to define a through-hole 35. The through-hole 35 may be open at the top and bottom. When the extractor 30 is inserted into the second insertion space 24, the heater 50 may pass through the through-hole 35 to protrude to the third insertion space 34. When the stick S is inserted into the third insertion space 34, the heater 50 may be inserted into a lower portion the stick S.

The induction coil 60 may surround the first insertion space 14. The induction coil 60 may surround the second insertion space 24. The induction coil 60 may surround the third insertion space 34. The induction coil 60 may be wound around the lateral wall 111 of the body pipe 11. The induction coil 60 may surround the heater 50. The induction coil 60 may allow the heater 50 to generate heat.

Accordingly, the stick S may be easily removed from the heater 50. The user may easily remove the stick S from the heater 50 by separating the extractor 30 and the heater holder 20 from each other. As the stick S that is inserted into the extractor 30 is removed from the heater 50, the stick S may be more easily separated from the extractor 30. The stick S may be removed without separating the extractor 30 and the heater holder 20 from each other.

In addition, a foreign material generated from the stick S may be extracted through the extractor 30 without remaining in the vicinity of the heater 50 and in the heater holder 20. Accordingly, cleaning of the aerosol generating device, namely, around the heater 50 may be facilitated, and the convenience of management may be improved. Also, a replacement period of the heater 50 may be extended by reducing factors that decease the performance of the heater 50 and by improving the durability of the heater 50. Further, factors that change the taste of the stick S may be reduced.

The inner coil 61 and the outer coil 62 may be wound around the lateral wall 111 of the body pipe 11. The outer coil 62 may be disposed outside the inner coil 61. The inner coil 61 and the outer coil 62 may surround the heater 50. The outer coil 62 may extend from one end of the inner coil 61. For example, the inner coil 61 may be wound around the lateral wall 111 of the body pipe 11 along an upward direction, and the outer coil 62 may extend from an upper end of the inner coil 61 so as to be wound around the inner coil 61 along a downward direction.

Accordingly, without increasing the vertical length of the coil, the strength of a magnetic field may be increased by increasing the number of turns of the coil.

The sensing coil 70 may be disposed below the induction coil 60. The sensing coil 70 may surround a lower portion of the first insertion space 14. The sensing coil 70 may surround a lower portion of the lateral wall 111 of the body pipe 11.

Accordingly, the sensing coil 70 may be disposed closer to the body pipe 11 or the first insertion space 14. As the sensing coil 70 surrounds the first insertion space 14, a sensing range may be increased. In addition, a sensor may not be required to pass through the induction coil 60 for sensing. As a result, sensing sensitivity and sensing accuracy may be improved.

The sensing coil 70 may surround a lower portion of the pipe 20′ of the heater holder 20. The sensing coil 70 may be adjacent to the lower wall 32 of the extractor 30. The induction coil 60 may be disposed at a height corresponding to the heating portion 52. The sensing coil 70 may be disposed at a height different from the heating portion 52. For example, the sensing coil 70 may be disposed at a height lower than the heating portion 52. The heating portion 52 may be disposed above the lower wall 32 of the extractor 30.

The heater holder 20 may be disposed between the body 10 and the extractor 30. The lateral wall 111 of the body pipe 11 may surround the lateral wall 21 of the heater holder 20. The lower wall 112 of the body pipe 11 may face the lower wall 22 of the heater holder 20. The lateral wall 21 of the heater holder 20 may surround the lateral wall 31 of the extractor 30. The lower wall 22 of the heater holder 20 may face the lower wall 32 of the extractor 30.

The lateral wall 31 of the extractor 30 may be spaced inward from the lateral wall 21 of the heater holder 20. The lower wall 32 of the extractor 30 may be spaced upward from the lower wall 22 of the heater holder 20. Air may flow between the extractor 30 and the heater holder 20, pass through the through-hole 35, and then be delivered to the stick S inserted into the third insertion space 34.

An upper wall 12 of the body 10 may extend outward from an upper end of the body pipe 11 along a horizontal direction. The upper wall 12 of the body 10 may cover an upper end of the induction coil 60. An outer lateral wall 13 of the body 10 may extend downward from an outer end of the upper wall 12 of the body 10. The outer lateral wall 13 of the body 10 may face the lateral wall 111 of the body pipe 11. The outer lateral wall 13 of the body 10 may be spaced outward from the body pipe 11. The induction coil 60 may be disposed between the body pipe 11 and the outer lateral wall 13 of the body 10.

An upper case 40 may be detachably coupled to the body 10. The upper case 40 may be coupled on top of the body 10. The upper case 40 may cover around the first insertion space 14 and an upper portion of the body 10. The upper case 40 may have an insertion hole 44. The stick S may be inserted into the insertion hole 44. The upper case 40 may include a cap 45 that opens and closes the insertion hole 44. The cap 45 may slide in the horizontal direction to open and close the insertion hole 44. The heater holder 20 may be disposed between the body 10 and the upper case 40.

The upper case 40 may include an upper case body 41. The upper case body 41 may be open at the top and bottom to define the insertion hole 44. The insertion hole 44 may be formed at a position eccentric toward one side from a center of the upper case body 41. A lower surface of the upper case body 41 may have a shape corresponding to the upper wall 12 of the body 10. The lower surface of the upper case body 41 may extend in the horizontal direction to be parallel with the upper wall 12 of the body 10. The cap 45 may be installed to be slidable on the upper case body 41.

The upper case 40 may include an upper case wing 42. The upper case wing 42 may extend downward from each of both sides of the upper case body 41. A portion of a lateral portion of the upper case body 41 may be exposed between a pair of upper case wings 42. The upper case wing 42 may be referred to as an upper case grip 42.

The extractor 30 may be coupled to the upper case 40. An upper end of the extractor 30 may be coupled to the upper case 40, and a lower end of the extractor 30 may protrude downward of the upper case 40. The extractor 30 may be coupled to a position corresponding to the insertion hole 44. The insertion hole 44 may be positioned on top of the third insertion space 34. The insertion hole 44 may allow the third insertion space 34 and an outside of the aerosol generating device to communicate with each other.

The upper end of the extractor 30 may be coupled to the upper case body 41. The extractor 30 may extend downward from the upper case body 41. The extractor 30 may be disposed between the pair of upper case wings 42.

The body 10 may include a body wing 16. The body wing 16 may extend upward from an edge of the upper wall 12 of the body 10. The body wing 16 may be provided in pair, and the pair of body wings 16 may be opposite each other with respect to the upper portion of the body 10. The body wing 16 may be formed at a position different from the upper case wing 42.

When the upper case 40 is coupled to the body 10, the upper case 40 may define an upper exterior of the aerosol generating device. When the upper case 40 is coupled to the body 10, the body wing 16 may cover the lateral portion of the upper case body 41 exposed between the pair of upper case wings 42. When the upper case 40 is coupled to the body 10, the upper case wing 42 may cover the outer lateral wall 13 of the body 10.

Accordingly, a user may more easily separate the extractor 30 from the body 10. Without the inconvenience of gripping the extractor 30 inserted into the second insertion space 24, the user may remove the extractor 30 while holding an exterior of the upper case 40. For example, the user may easily remove the upper case 40 and the extractor 30 from the body 10 by holding and pulling the pair of upper case wings 42 from the body 10.

The extractor 30 may include an engaging protrusion 37. The engaging protrusion 37 may protrude outward from an outer circumferential surface of the upper end of the extractor 30 along the horizontal direction. A plurality of engaging protrusions 37 may be provided. The plurality of engaging protrusions 26 may be spaced apart from each other in the circumferential direction. The engaging protrusion 37 may be inserted and caught in a recess, which is formed in the upper case body 41, in the vicinity of the insertion hole 44, allowing the extractor 30 to be fixed to the upper case 40. The engaging protrusion 37 may be engaged with the upper case body 41 in the circumferential direction.

Accordingly, the extractor 30 may be prevented from being rotated in the circumferential direction with respect to the upper case 40 during insertion and removal of the stick S.

The heater holder 20 may include an extension portion 23. The extension portion 23 may be formed at an upper end of the heater holder 20. The extension portion 23 may extend outward from an upper end of the pipe 20′ along the horizontal direction. The extension portion 23 may have a plate shape. One side of the extension portion 23 may be longer with respect to the pipe 20′. The extension portion 23 may be referred to as a heater holder extension portion 23.

The extension portion 23 may have a shape corresponding to the upper wall 12 of the body 10. The extension portion 23 may be formed horizontally with respect to the upper wall 12 of the body 10. When the pipe 20′ is inserted into the first insertion space 14, the extension portion 23 may be supported or seated on the upper wall 12 of the body 10. The upper wall 12 of the body 10 may support the extension portion 23, and the extension portion 23 may support the pipe 20′. The pipe 20′ may be spaced upward from the bottom 112 of the body pipe 11 while being suspended on the extension portion 23, thereby forming an air gap. An outer circumferential surface of the pipe 20′ may be spaced inward from the lateral wall 111 of the body pipe 11 to thereby form an air gap.

The extension portion 23 may have a shape corresponding to the lower surface of the upper case body 41. The extension portion 23 may be formed horizontally with respect to the lower surface of the upper case body 41. When the upper case 40 is coupled to the body 10, the extractor 30 may be inserted into the pipe 20′, allowing the extension portion 23 to be in contact with the lower surface of the upper case body 41.

A first coupling member 27 may be fixed to the heater holder 20. For example, the first coupling member 27 may be fixed to the extension portion 23. The first coupling member 27 may be fixed inside the extension portion 23 or fixed to an outer surface of the extension portion 23. The heater holder 20 may be insert-injected to the first coupling member 27 and the heater 50.

The extension portion 23 may include a first extension potion 231 and a second extension portion 232. The first extension portion 231 may extend to one side from the pipe 20′, and the second extension portion 232 may extend to another side from the pipe 20′. The first extension portion 231 may extend longer than the second extension portion 232. A circumference of the first extension portion 231 may be greater than a circumference of the second extension portion 232. The first extension portion 231 may be wider in the horizontal direction than the second extension portion 232. With respect to the pipe 20′ extending downward from the extension portion 23 of the plate shape, one side may be defined as the first extension portion 231 and another side may be defined as the second extension portion 232. The pipe 20′ may extend downward from a portion eccentric to one side from a center of the extension portion 23.

Of the portions of the extension portion 23, the first coupling member 27 may be fixed to the first extension portion 231 extending longer to one side with respect to the pipe 20′. The first coupling member 27 may have a plate shape. The first coupling member 27 may be widely disposed at the first extension portion 23 in the horizontal direction. The position at which the first coupling member 27 is disposed is not limited thereto. For example, the first coupling member 27 may be fixed to the pipe 20′.

The first coupling member 27 may be made of a magnetic material. The first coupling member 27 may be ferromagnetic. For example, the first coupling member 27 may be made of stainless steel. However, the material of the first coupling member 27 is not limited thereto.

A second coupling member 47 may be fixed to the upper case 40. The second coupling member 47 may be fixed inside the upper case body 41. The second coupling member 47 may be adjacent to the lower surface of the upper case body 41. However, the position at which the second coupling member 47 is disposed is not limited thereto. For example, the second coupling member 47 may be fixed to the upper case wing 42. As another example, the second coupling member 47 may be fixed to the extractor 30. The second coupling member 47 may be disposed at a position corresponding to the first coupling member 27.

An attractive force may act between the second coupling member 47 and the first coupling member 27. For example, the first coupling member 27 may be a ferro-magnetic material, and the second coupling member 47 may be a magnet. However, the material of the first coupling member 27 and the material of the second coupling member 47 are not limited thereto.

A third coupling member 17 may be fixed inside the body 10. The third coupling member 17 may be adjacent to the upper wall 12 of the body 10. The third coupling member 17 may be disposed at a position corresponding to the first coupling member 27. However, the position at which the third coupling member 17 is disposed is not limited thereto. For example, the third coupling member 17 may be adjacent to the lateral wall 111 of the body pipe 11. An attractive force may act between the third coupling member 17 and the first coupling member 27. For example, the first coupling member 27 may be a ferromagnetic material, and the third coupling member 17 may be a magnet. However, the material of the first coupling member 27 and the material of the third coupling member 17 are not limited thereto.

Referring to FIGS. 4 and 5, a frame 18 may be disposed at a lower side of an upper body 10a. The frame 18 may be disposed outside the body pipe 11. The frame 18 may support the induction coil 60. The frame 18 may support the sensing coil 70. The induction coil 60 may be disposed at an upper side of the frame 18. The sensing coil 70 may be disposed at the upper side of the frame 18.

The frame 18 may include a first frame 181 and a second frame 182. The second frame 182 may be coupled on top of the first frame 181. The second frame 182 may be surrounded by the upper wall 12, the inner lateral wall 111, and the outer lateral wall 13 of the upper body 10a. The third coupling member 17 may be disposed between the upper wall 12 of the upper body 10a and the second frame 182. The third coupling member 17 may be fixed to a fixing portion 187 formed on one side of the second frame 182. A portion of the first frame 181 may be disposed under the body pipe 11. Another portion of the first frame 181 may be inserted into the second frame 182.

A coil placement space 114 may be defined by the inner lateral wall 111, the upper wall 12, and the outer lateral wall 13 of the upper body 10a. The coil placement space 114 may surround the inner lateral wall 111. The coil placement space 114 may be open at the bottom.

An induction coil hole 64 may be surrounded by the induction coil 60, and may be open at the top and bottom. A sensing coil hole 74 may be surrounded by the sensing coil 70, and may be open at the top and bottom. The induction coil hole 64 and the sensing coil hole 74 may be arranged up and down. For example, the sensing coil hole 74 may be disposed below the induction coil hole 64. The second frame 182 may be open to define a frame hole 184. The frame hole 184 may be formed below the induction coil hole 64 and the sensing coil hole 74. The induction coil hole 64, the sensing coil hole 74, and the frame hole 184 may have a shape corresponding to the lateral wall 11 of the body pipe 11. A pipe holder 187 may surround the frame hole 184. The pipe holder 187 may be formed on the frame 18. The pipe holder 187 may have a ring shape. The pipe holder 187 may be a portion of the second frame 182.

The body pipe 11 may pass through the induction coil hole 64 and the sensing coil hole 74. When the body pipe 11 passes through the induction coil hole 64 and the sensing coil hole 74, the induction coil 60 and the sensing coil 70 may be disposed in the coil placement space 114, and the body pipe 11 and the first insertion space 14 may be surrounded by the induction coil 60 and the sensing coil 70. A circumference of a lower portion of the body pipe 11 may be inserted into the frame hole 184 to be surrounded by the pipe holder 187. The circumference of the lower portion of the body pipe 11 may be supported by the pipe holder 187.

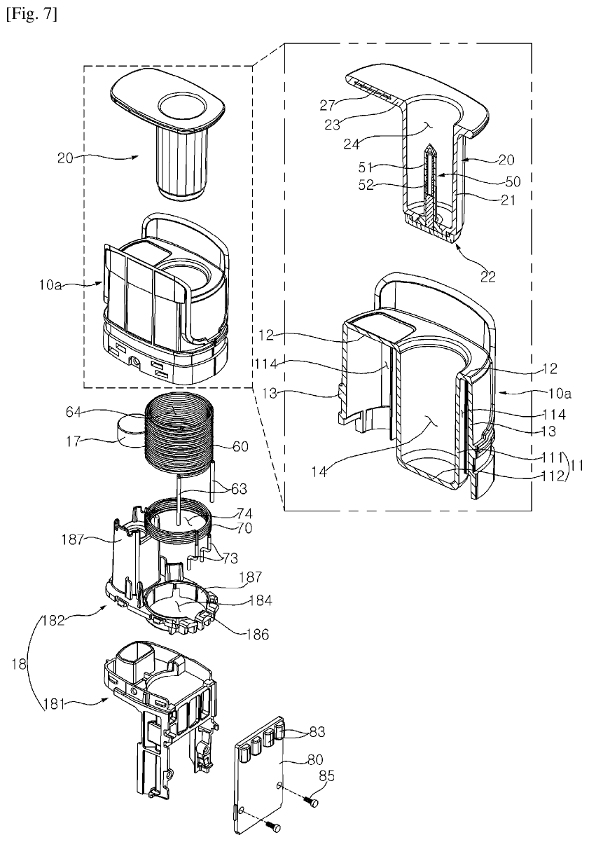

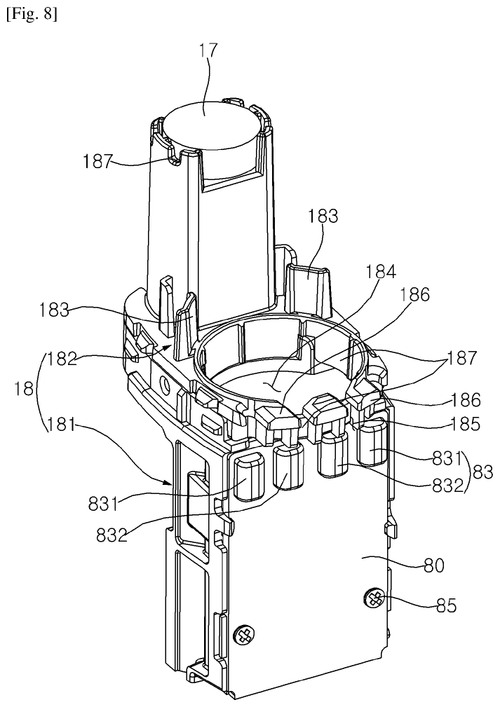

Referring to FIGS. 7 and 8, as the induction coil 60 is connected to the substrate 80, the induction coil 60 may be controlled its operation by the controller 102 and may be supplied with power from the battery 101. As the sensing coil 70 is connected to the substrate 80, the sensing coil 70 may be controlled its operation by the controller 102 and may be supplied with power from the battery 101.

The substrate 80 may be coupled to the frame 18. For example, the substrate 80 may be coupled to one side of the frame 18 through a screw 85. The substrate 80 may be vertically disposed on one side of the first frame 181 in an elongated manner. The substrate 80 may be coupled to the first frame 181, and may be disposed under the second frame 182.

The substrate 80 may include a connector 83. The connector 83 may include a pair of first connectors 831 and a pair of second connectors 832. The first connector 831 may connect the induction coil 60 and the substrate 80. Both ends of the induction coil 60 may be electrically connected to the pair of first connectors 831, respectively. The second connector 832 may connect the sensing coil 70 and the substrate 80. Both ends of the sensing coil 70 may be electrically connected to the pair of second connectors 832, respectively. The connector 83 may be disposed on the substrate 80 to be adjacent to a lower side of the second frame 18.

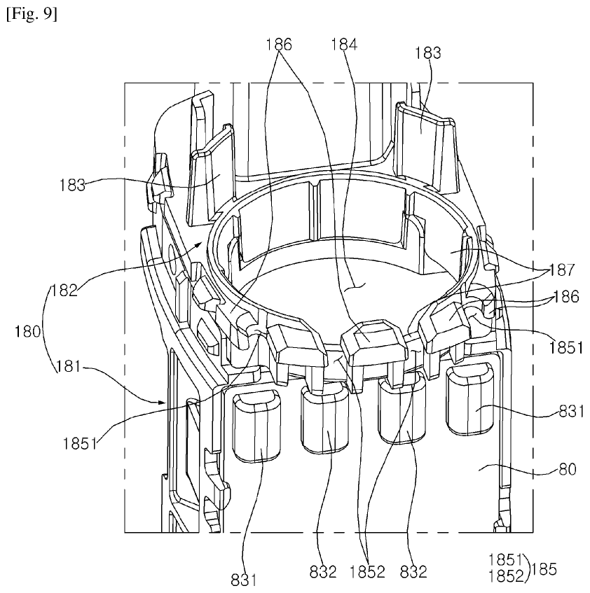

Referring to FIG. 9, a splitter 186 may be disposed above the substrate 80 and the connector 83. The splitter 186 may be formed on one side of the frame 18. For example, the splitter 186 may protrude from the pipe holder 187. A plurality of splitters 186 may be provided. The plurality of splitters 186 may be arranged around the frame hole 184 to be spaced apart from each other above the connector 83. A splitter hole 185 may be formed between the plurality of splitters 186.

The splitter hole 185 may be provided in plurality. The plurality of splitter holes 185 may be formed at positions corresponding to the respective plurality of connectors 83. For example, four splitter holes 185 may be formed.

The splitter hole 185 may include a pair of first splitter holes 1851 and a pair of second splitter holes 1852. The pair of first splitter holes 1851 may be positioned above the respective pair of first connectors 831 in a corresponding manner. The pair of second splitter holes 1852 may be positioned above the respective pair of second connectors 832 in a corresponding manner.

A supporter 183 may protrude from the frame 18. The supporter 183 may be formed in the vicinity of the frame hole 184. The supporter 183 may support the induction coil 60.

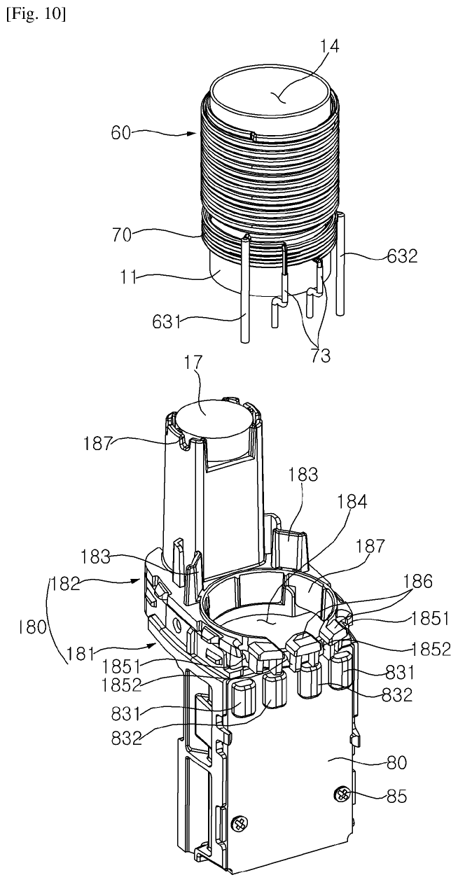

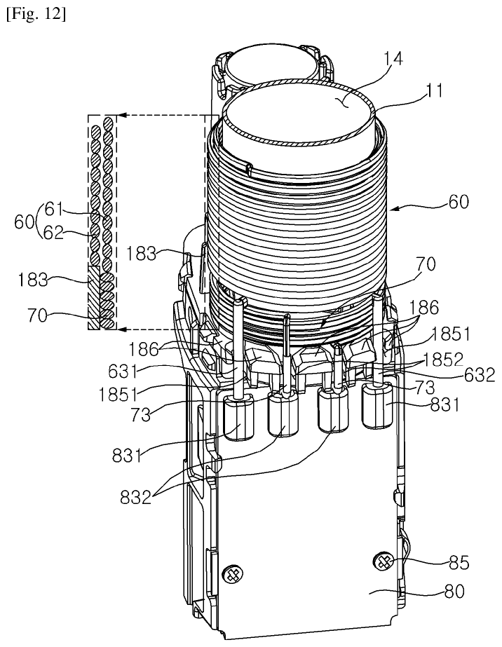

Referring to FIGS. 10 to 12, of the upper body 10a (see FIG. 7), only the body pipe 11 is shown to illustrate the induction coil 60 and the sensing coil 70, for the sake of convenience. The induction coil 60 and the sensing coil 70 may surround the body pipe 11. The sensing coil 70 may be disposed at a lower side of the induction coil 60.

The induction coil 60 may include the inner coil 61 and the outer coil 62. As an upper end of the inner coil 61 is connected to an upper end of the outer coil 62, the inner coil 61 and the outer coil 62 may be integrally formed with each other. The inner coil 61 may be wound around the body pipe 11 in one direction (e.g., a counter-clockwise direction) along the upward direction, and the outer coil 62 may extend from the upper end of the inner coil 61 to be wound around the inner coil 61 in one direction (e.g., a counterclockwise direction) along the downward direction. A lower end of the outer coil 62 may be adjacent to a lower end of the inner coil 61. Thus, the body pipe 11 may be doubly wound.

A pair of induction lead wires 631 and 632 may be connected to the pair of first connectors 831, respectively. Accordingly, the induction coil 60 may be electrically connected to the substrate 80. The pair of induction lead wires 631 and 632 may extend downward from both ends of the induction coil 60, respectively. A first induction lead wire 631 may be elongated downward from the lower end of the inner coil 61. A second induction lead wire 632 may be elongated downward from the lower end of the outer coil 62. An upper end of the first induction lead wire 631 and an upper end of the second induction lead wire 632 may be formed at similar heights.

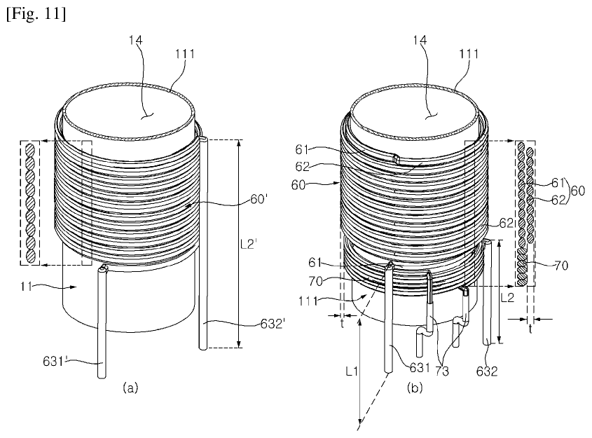

As for an induction coil 60′ of the related art shown in (a) of FIG. 11, a pair of induction lead wires 631′ and 632′ extend downward from upper and lower ends of the induction coil 60′, respectively. In this case, the length of the induction lead wire 632′ extending downward from the upper end of the induction coil 60′ is too long, which is structurally unstable to thereby have a greater risk of disconnection. Also, since the induction lead wire 632′ extends downward while overlapping the outside of the induction coil 60′, the exterior of the induction coil 60′ protrudes in the radial direction, which is disadvantageous in terms of assembly and matching with another structure.

However, in the case of the present disclosure shown in (b) of FIG. 11, the induction coil 60 may include the inner coil 61 and the outer coil 62, and, of the pair of induction lead wires 631 and 632, the first induction lead wire 631 may extend downward from the lower end of the inner coil 61, and the second induction lead wire 632 may extend downward from the lower end of the outer coil 62. A length L2 of the second induction lead wire 632, which corresponds to the induction lead wire 632′ of the related art induction coil 60′, may be less than a length L2′ of the induction lead wire 632′. The length L2 of the second induction lead wire 632 may be similar to a length L1 of the first induction lead wire 631.

Accordingly, structural stability of the lead wire may be improved, and the risk of disconnection may be reduced. In addition, by making the outer shape of the induction coil 60 round, assembly and matching with an outer structure may be improved. For example, assembly and structural matching with the outer lateral wall 13 of the upper body 10a (see FIG. 7) may be improved. In addition, the strength of a magnetic field may be increased without increasing the vertical length of the induction coil 60.

The first induction lead wire 631 and the second induction lead wire 632 may be disposed at positions corresponding to the respective pair of first splitter holes 1851. The first induction lead wire 631 and the second induction lead wire 632 may be disposed at positions corresponding to the respective pair of first connectors 831. The first induction lead wire 631 may pass through any one of the pair of first splitter holes 1851 to be connected to any one of the pair of first connectors 831. The second induction lead wire 632 may pass through the remaining one of the pair of first splitter holes 1851 to be connected to the remaining one of the pair of first connectors 831.

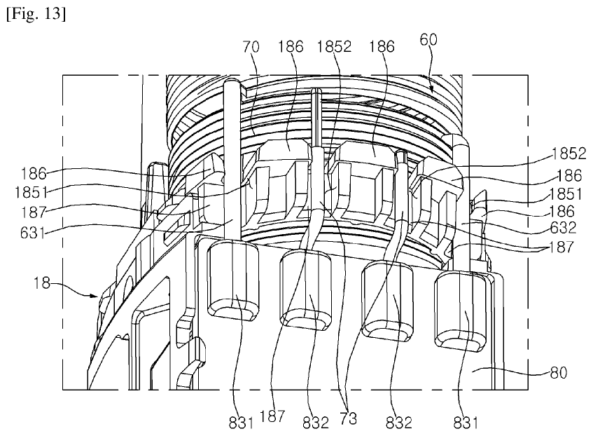

A pair of sensing lead wires 73 may extend downward from both ends of the sensing coil 70, respectively. For example, the pair of sensing lead wires 73 may be disposed between the pair of induction lead wires 631 and 632. The pair of sensing lead wires 73 may be disposed at positions corresponding to the respective pair of second splitter holes 1852. The pair of sensing lead wires 73 may be disposed at positions corresponding to the respective pair of second connectors 832. The pair of sensing lead wires 73 may pass through the respective pair of second splitter holes 1852, so as to be connected to the respective pair of second connectors 832. The sensing lead wire 73 may be supported by the pipe holder 187 that surrounds the lower portion of the body pipe 11 (see FIG. 13).

The pair of sensing lead wires 73, the first induction lead wire 631, and the second induction lead wire 632 may each be disposed at intervals between the plurality of splitters 186. The splitter 186 may arrange and space the pair of sensing lead wires 73, the first induction lead wire 631, and the second induction lead wire 632 apart to thereby prevent contact therebetween. The splitter 186 may support the pair of sensing lead wires 73, the first induction lead wire 631, and the second induction lead wire 632 to fix their positions.

Accordingly, contact and interference between the lead wires may be prevented. In addition, the lead wires may be arranged in a stable manner. Further, disconnection of the lead wires may be prevented.

As the induction coil 60 is doubly wound around the body pipe 11, a radius of an outer circumferential surface of the induction coil 60 may be greater than that of the sensing coil 70 that is singly wound around the body pipe 11. A predetermined width t may be formed between the outer circumferential surface of the sensing coil 70 and the outer circumferential surface of the induction coil 60 in a radial direction. The induction coil 60 may protrude to the predetermined width t in the radial direction relative to the sensing coil 70.

The supporter 183 may support the induction coil 60 and/or the sensing coil 70. For example, the supporter 183 may support a lower portion of the outer coil 62. For example, the supporter 183 may support the outer circumferential surface of the sensing coil 70. The supporter 183 may keep the induction coil 60 and the sensing coil apart or separate the induction coil 60 and the sensing coil 70 from each other so as to prevent contact between the induction coil 60 and the sensing coil 70.

In one embodiment, the supporter 183 may be formed on the frame 18. In another embodiment, the supporter 183 may protrude outward from the lateral wall 111 of the body pipe 11, between the induction coil 60 and the sensing coil 70. However, these are just some of the embodiments, and the position at which the supporter 183 is formed is not limited thereto. Any other positions may be used so long as the position is capable of separating the induction coil 60 from the sensing coil 70 to prevent contact therebetween and of supporting the induction coil 60 and/or the sensing coil 70.

The induction lead wires 631 and 632 may pass through an outside of the sensing coil 70. The induction lead wires 631 and 632 may be supported by the pipe holder 187 that surrounds the circumference of the lower portion of the body pipe 11 (see FIG. 13). The pipe holder 187 (see FIG. 13) may separate the induction lead wires 631 and 632 from the outside of the sensing coil 70 to prevent contact therebetween.

Accordingly, interference between the induction coil 60 and the sensing coil 70 may be prevented.

Referring to FIG. 14, the induction coil 60 may be disposed at a height corresponding to the heating portion 52 of the heater 50. A vertical length L31 of the induction coil 60 may be greater than a vertical length L30 of the heating portion 52. The heating portion 52 may be disposed at a height between upper and lower ends of the induction coil 60.

The inner coil 61 and the outer coil 62 may be wound around the insertion space 14 in the same direction. A vertical length of the inner coil 61 and a vertical length of the outer coil 62 may be equal or similar to each other. For example, the vertical length of the inner coil 61 and the vertical length of the outer coil 62 may be L31. The inner coil 61 may be disposed at a height corresponding to the heating portion 52. The outer coil 62 may be disposed at a height corresponding to the heating portion 52. The number of windings of the outer coil 62 may be equal or similar to the number of windings of the inner coil 61. The number of windings per length of the outer coil 62 may be equal or similar to the number of windings per length of the inner coil 61.

The sensing coil 70 may be disposed below the induction coil 60. The vertical length L31 of the induction coil 60 may be greater than a vertical length L33 of the sensing coil 70. The sensing coil 70 may be disposed at a height different from the heating portion 52, below the heating portion 52.

Accordingly, without increasing the vertical length of the induction coil 60, the intensity of a magnetic field that affects the heater 50 may be increased by increasing the number of turns of the induction coil 60. In addition, a region where the heater 50 generates heat by the induction coil 60 and a region where the sensing coil 70 senses may be separated into upper and lower regions. Further, sensing noise may be reduced, and sensing accuracy may be improved.

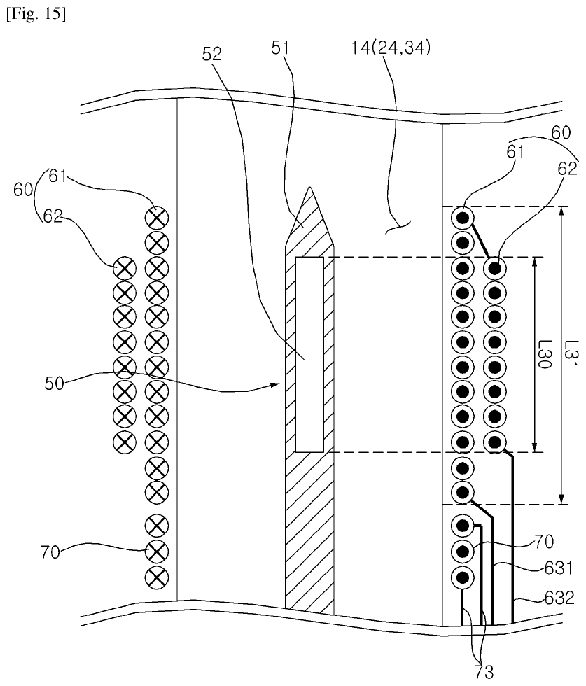

Referring to FIG. 15, a vertical length L30 of the outer coil 62 may be less than a vertical length L31 of the inner coil 61. The vertical length L30 of the outer coil 62 may be equal or similar to a vertical length L30 of the heating portion 52. The outer coil 62 may be disposed at a height between upper and lower ends of the inner coil 61. The outer coil 62 may be disposed at a height corresponding to the heating portion 52. The number of windings of the outer coil 62 may be less than the number of windings of the inner coil 61. The number of windings per length of the outer coil 62 may be equal or similar to the number of windings per length of the inner coil 61.

As the induction coil 60 is doubly wound around the heater 50, the strength of a magnetic field in the desired area may be increased while reducing the material required for the manufacture of the induction coil 60.

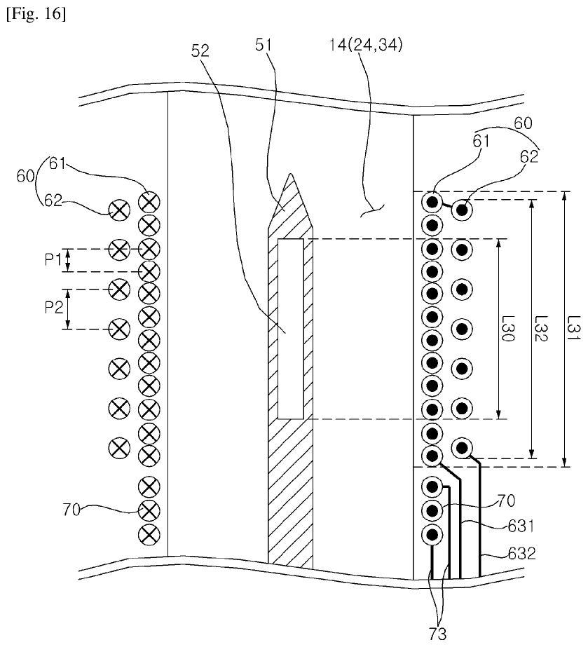

Referring to FIG. 16, a pitch P1 of the inner coil 61 and a pitch P2 of the outer coil 62 may be different from each other. For example, the pitch P2 of the outer coil 62 may be greater than the pitch P1 of the inner coil 61. A vertical length L32 of the outer coil 62 may be less than a vertical length L31 of the inner coil 61. The number of windings of the outer coil 62 may be less than the number of windings of the inner coil 61. The number of windings per length of the outer coil 62 may be less than the number of windings per length of the inner coil 61.

As the induction coil 60 is doubly wound around the heater 50, the strength of a magnetic field in the desired area may be increased while reducing the material required for the manufacture of the induction coil 60.

Referring to FIGS. 17 and 18, the sensing coil 70 may be disposed above the induction coil 60. The sensing coil 70 may be disposed at a height different from the heating portion 52, above the heating portion 52. When the extractor 30 supports the stick S, the sensing coil 70 may be disposed at a position higher than the lower wall 32 of the extractor 30. For example, a lower end of the heating portion 52 may be adjacent to the lower wall 32 of the extractor 30, and the sensing coil 70 may be disposed at a position higher than the lower wall 32 of the extractor 30 and an upper end of the heating portion 52.

A pair of sensing lead wires 73 may extend downward from both ends of the sensing coil 70, respectively, to pass through an outside of the induction coil 60. Accordingly, the sensing lead wire 73 may be prevented from generating heat by the induction coil 60.

Referring to FIGS. 1 to 18, an aerosol generating device according to an aspect of the present disclosure may include: a body shaped to define an insertion space; a heater located within the insertion space; a sensing coil positioned around the insertion space; a capacitance sensor coupled to the sensing coil and being configured to measure a capacitance in a vicinity of the sensing coil; an inductive sensor coupled to the sensing coil and being configured to measure an inductance in the vicinity of the sensing coil; and a switch configured to electrically connect the sensing coil to any one of the capacitance sensor or the inductive sensor.

According to another aspect of the present disclosure, the aerosol generating device may further include an induction coil positioned around the insertion space and being configured to cause the heater to generate heat.

According to another aspect of the present disclosure, the sensing coil may be disposed below the induction coil and is wound around a lower portion of the insertion space.

According to another aspect of the present disclosure, the aerosol generating device may further include: a substrate on which the capacitance sensor and the inductive sensor are coupled, wherein the substrate is located below the sensing coil; and an induction lead wire extending from the induction coil, is coupled to the substrate, and passes through an outside of the sensing coil.

According to another aspect of the present disclosure, the sensing coil may be disposed above the induction coil and is wound around an upper portion of the insertion space.

According to another aspect of the present disclosure, the aerosol generating device may further include: a substrate on which the capacitance sensor and the inductive sensor are coupled, wherein the substrate is disposed below the induction coil; and a sensing lead wire extending from the sensing coil, is coupled to the substrate, and passes through an outside of the induction coil.

According to another aspect of the present disclosure, the induction coil may be disposed at a height that generally corresponds to the heater, and the sensing coil is disposed at a height different from that of the heater.

According to another aspect of the present disclosure, the aerosol generating device may further include: a substrate on which the capacitance sensor and the inductive sensor are coupled, wherein the substrate is disposed below the sensing coil; a pair of sensing lead wires extending from respective ends of the sensing coil and coupling with the substrate; and a splitter disposed between the pair of sensing lead wires to separate the pair of sensing lead wires from each other.

According to another aspect of the present disclosure, the pair of sensing lead wires may pass through splitter holes, which are formed at intervals between adjacent splitters, from among a plurality of splitters, and the aerosol generating device may further include a plurality of connectors coupled to the substrate, the plurality of connectors each being disposed at a position adjacent to a corresponding one of the splitter holes and each being coupled to one end of one of the pair of sensing lead wires.

According to another aspect of the present disclosure, the aerosol generating device may further include: an induction lead wire extending from the induction coil and being coupled to the substrate; a sensing lead wire extending from the sensing coil and being coupled to the substrate; and a splitter separating the induction lead wire and the sensing lead wire from each other.

According to another aspect of the present disclosure, the splitter may be disposed below the induction coil and the sensing coil, and the substrate may be disposed below the splitter.

According to another aspect of the present disclosure, the aerosol generating device may further include a controller to control an operation of the switch, the controller may be configured to: determine, when the switch provides an electrical connection between the sensing coil and the capacitance sensor, a state in the vicinity of the sensing coil based on the capacitance measured by the capacitance sensor; and determine, when the switch provides an electrical connection between the sensing coil and the inductive sensor, a state in the vicinity of the sensing coil based on the inductance measured by the inductive sensor.

Referring to FIGS. 1 to 18, an aerosol generating device according to an aspect of the present disclosure may include: a body shaped to define an insertion space; a heater located within the insertion space; and an induction coil positioned around the insertion space and being configured to cause the heater to generate heat, the induction coil may include: an inner coil positioned around at least a portion of the insertion space; and an outer coil extending from the inner coil and positioned around at least a portion of the inner coil and the insertion space, and at an outer side of the inner coil.

According to another aspect of the present disclosure, the inner coil and the outer coil may be wound in a same direction.

According to another aspect of the present disclosure, the inner coil may be wound around the at least a portion of the insertion space in a circumferential direction and in an upward direction, and the outer coil may extend from an upper end of the inner coil, and is wound around the at least a portion of the insertion space in the circumferential direction and in a downward direction.

According to another aspect of the present disclosure, the aerosol generating device may further include: a substrate accommodated in the body below the induction coil and electrically coupled to the induction coil; a first induction lead wire extending downward from a lower end of the inner coil and being coupled to the substrate; and a second induction lead wire extending downward from a lower end of the outer coil and being coupled to the substrate.

According to another aspect of the present disclosure, a height of an upper end of the first induction lead wire and a height of an upper end of the second induction lead wire may be substantially the same.

According to another aspect of the present disclosure, the aerosol generating device may further include a splitter disposed below the induction coil between the first induction lead wire and the second induction lead wire, and the splitter separates the first induction lead wire and the second induction lead wire from each other.

According to another aspect of the present disclosure, the aerosol generating device may further include a plurality of splitters, each of the plurality of splitters is positioned to form a splitter hole between each of the plurality of splitters; and a plurality of connectors located on the substrate, each of the plurality of connectors is positioned adjacent to a corresponding one of the plurality of splitter holes, and the first induction lead wire and the second induction lead wire may pass through a respective one of the plurality of splitter holes to permit coupling with a respective one of the plurality of connectors

According to another aspect of the present disclosure, the second induction lead wire may be disposed outside of the inner coil.

According to another aspect of the present disclosure, the inner coil and the outer coil may be disposed at a height generally corresponding to the heater.

According to another aspect of the present disclosure, a vertical length of the inner coil and a vertical length of the outer coil may correspond to each other.

According to another aspect of the present disclosure, a vertical length of the outer coil may be less than a vertical length of the inner coil.

According to another aspect of the present disclosure, a pitch of the outer coil may be less than a pitch of the inner coil.

According to another aspect of the present disclosure, a number of windings of the outer coil may be less than a number of windings of the inner coil.

According to another aspect of the present disclosure, a radius of the outer coil may be greater than a radius of the inner coil.

According to another aspect of the present disclosure, an aerosol generating device may include: a body shaped to define an insertion space; a heater located within the insertion space; and an induction coil positioned outside of the insertion space and being configured to cause the heater to generate heat, and the induction coil may include: an inner coil positioned relative to a first portion of the insertion space; and an outer coil extending from the inner coil and positioned relative to a second portion of the insertion space, and the first portion may be different from the second portion, and a portion of the inner coil may be located between the outside of the insertion space and the outer coil.

Certain embodiments or other embodiments of the disclosure described above are not mutually exclusive or distinct from each other. Any or all elements of the embodiments of the disclosure described above may be combined with another or combined with each other in configuration or function.

For example, a configuration “A” described in one embodiment of the disclosure and the drawings, and a configuration “B” described in another embodiment of the disclosure and the drawings may be combined with each other. Namely, although the combination between the configurations is not directly described, the combination is possible except in the case where it is described that the combination is impossible.

Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings, and the appended claims. In addition to variations and modifications in the component parts and/or arrangements, alternative uses will also be apparent to those skilled in the art.

1. An aerosol generating device comprising:
a body shaped to define an insertion space;
a heater located within the insertion space;
a sensing coil positioned around the insertion space;
a capacitance sensor coupled to the sensing coil and being configured to measure a capacitance in a vicinity of the sensing coil;
an inductive sensor coupled to the sensing coil and being configured to measure an inductance in the vicinity of the sensing coil; and
a switch configured to electrically connect the sensing coil to any one of the capacitance sensor or the inductive sensor.

2. The aerosol generating device of claim 1, further comprising an induction coil positioned around the insertion space and being configured to cause the heater to generate heat.

3. The aerosol generating device of claim 2, wherein the sensing coil is disposed below the induction coil and is wound around a lower portion of the insertion space.

4. The aerosol generating device of claim 3, further comprising:
a substrate on which the capacitance sensor and the inductive sensor are coupled, wherein the substrate is located below the sensing coil; and
an induction lead wire extending from the induction coil, is coupled to the substrate, and passes through an outside of the sensing coil.

5. The aerosol generating device of claim 2, wherein the sensing coil is disposed above the induction coil and is wound around an upper portion of the insertion space.

6. The aerosol generating device of claim 5, further comprising:
a substrate on which the capacitance sensor and the inductive sensor are coupled, wherein the substrate is disposed below the induction coil; and
a sensing lead wire extending from the sensing coil, is coupled to the substrate, and passes through an outside of the induction coil.

7. The aerosol generating device of claim 4, wherein the induction coil is disposed at a height that generally corresponds to the heater, and
wherein the sensing coil is disposed at a height different from that of the heater.

8. The aerosol generating device of claim 1, further comprising:
a substrate on which the capacitance sensor and the inductive sensor are coupled, wherein the substrate is disposed below the sensing coil;
a pair of sensing lead wires extending from respective ends of the sensing coil and coupling with the substrate; and
a splitter disposed between the pair of sensing lead wires to separate the pair of sensing lead wires from each other.

9. The aerosol generating device of claim 8, wherein the pair of sensing lead wires pass through splitter holes, which are formed at intervals between adjacent splitters, from among a plurality of splitters, and
wherein the aerosol generating device further comprises a plurality of connectors coupled to the substrate, the plurality of connectors each being disposed at a position adjacent to a corresponding one of the splitter holes and each being coupled to one end of one of the pair of sensing lead wires.

10. The aerosol generating device of claim 2, further comprising:
an induction lead wire extending from the induction coil and being coupled to the substrate;
a sensing lead wire extending from the sensing coil and being coupled to the substrate; and
a splitter separating the induction lead wire and the sensing lead wire from each other.

11. The aerosol generating device of claim 8, wherein the splitter is disposed below the induction coil and the sensing coil, and
wherein the substrate is disposed below the splitter.

12. The aerosol generating device of claim 1, further comprising a controller to control an operation of the switch,
wherein the controller is configured to:
determine, when the switch provides an electrical connection between the sensing coil and the capacitance sensor, a state in the vicinity of the sensing coil based on the capacitance measured by the capacitance sensor; and
determine, when the switch provides an electrical connection between the sensing coil and the inductive sensor, a state in the vicinity of the sensing coil based on the inductance measured by the inductive sensor.
